(19) United States
(12) Patent Application Publication
(10) Pub. No.: US 2013/0146582 A1
(43) Pub. Date: Jun. 13, 2013

(54) Heating Device, Cooking Field and Method for Operating a Heating Device

(71) Applicants: Eugen Wilde, Knittlingen (DE); Hans Mohr, Sulzfeld (DE)

(72) Inventors: Eugen Wilde, Knittlingen (DE); Hans Mohr, Sulzfeld (DE)

(73) Assignee: E.G.O. Elektro-Gerätebau GmbH, Oberderdingen (DE)

(21) Appl. No.: 13/315,677

(22) Filed: Dec. 9, 2011

(51) Int. Cl. H05B 3/68

(52) U.S. Cl. 219/448.11

(57) ABSTRACT

A heating device for a cooking field is arranged beneath a cooking field plate, wherein the heating device comprises a temperature sensor and a wire heating element for generating heating power. The temperature sensor is provided between the heating element and the cooking field plate and has a longitudinal and rod-like sensing part. The heating element is arranged directly beneath and aligned with the sensing part such that the sensing part is exposed to heating power from the heating element. The heating power ranges in power from 0.5 W up to 2.5 W per centimeter of length of the sensing part. This serves for a faster activation of a residual heat indicator by the temperature sensor.

### CROSS REFERENCE TO RELATED APPLICATIONS

This application is related to:

U.S. patent application Ser. No. ______, filed on ______, entitled “Heating Device, Method Of Producing A Heating Device And Method For Operating A Heating Device,” which is also identified by attorney docket number P51796/113.0012US01; and

U.S. patent application Ser. No. ______, filed on ______, entitled “Control Device For An Electrical Heating Device For A Cooking Field, Cooking Field And Method For Operating Such An Electrical Heating Device,” which is also identified by attorney docket number P51853/60113.0013US01, the contents of both of which are incorporated by reference for all that they teach.

### FIELD OF APPLICATION

The disclosure generally relates to a cooktop, and more specifically to a heating device for a cooking field with a cooking field plate, to such a cooking field, as well as to a method for operating such a heating device.

### BACKGROUND

It is known from the prior art to provide heating devices for a cooking field, especially radiating heating devices, for example according to U.S. Pat. No. 4,633,238 or U.S. Pat. No. 5,498,853, with a temperature sensor for sensing the temperature of the upper surface of the cooking field plate. In case this temperature is above a range of 50° C. to 90° C., a residual heat signaling indicator is activated to warn a user from touching the hot cooking field plate.

Furthermore, heating devices for a cooking field are known, for example from U.S. Pat. No. 4,371,780, that provide a relatively small output of heating power. They can be operated continuously to keep food in a saucepan or the like placed above the heating device onto the cooking field plate at a convenient temperature for being directly served. A low power output of such a heating device enables it to be operated without the need of a temperature sensor to avoid damage to the cooking field plate by overheating it.

### SUMMARY

A heating device is provided for a cooking field with a safe way to operate a temperature sensor as well as to provide a cooking field with such a heating device and to provide a method for operating such a heating device. In another embodiment, a heating device is provided with a temperature sensor to operate a residual heat indicator.

In one embodiment disclosed herein, a heating device for a cooking appliance includes a cooking field plate, a portion of which forms a cooking field. The heating device includes a temperature sensor includes a longitudinal and rod-like sensing part, and a longitudinal heating element for generating and radiating heating power in a direction to and through the cooking field plate, wherein the temperature sensor is provided between the heating element and the cooking field plate, wherein the heating element is arranged under the sensing part such that the sensing part is exposed to heating power from the heating element, the heating power ranging from 0.5 W up to 2.5 W per centimeter (“cm”) of length of the sensing part.

In another embodiment provided herein, a cooking appliance includes a cooking field with a portion thereof forming a cooking field plate, and a heating device arranged beneath the cooking field plate. The heating device includes a temperature sensor that includes a longitudinal and rod-like sensing part and a longitudinal heating element for generating and radiating heating power in a direction to and through the cooking field plate, wherein the temperature sensor is provided between the heating element and the cooking field plate, wherein the heating element is arranged under the sensing part such that the sensing part is exposed to heating power from the heating element, the heating power ranging from 0.5 W up to 2.5 W per centimeter (“cm”) of length of the sensing part and at least one other heating device arranged beneath the cooking field plate, wherein the at least one other heating device is of different construction.

In another embodiment disclosed herein, a method for operating a heating device includes a temperature sensor that includes a longitudinal and rod-like sensing part, and a longitudinal heating element for generating and radiating heating power in a direction to and through the cooking field plate. The temperature sensor is provided between the heating element and the cooking field plate, wherein the heating element is arranged under the sensing part such that the sensing part is exposed to heating power from the heating element, the heating power ranging from 0.5 W up to 2.5 W per centimeter (“cm”) of length of the sensing part. The method includes heating the heating element with a heating power of 0.5 up to 2.5 W/cm of its length, heating the sensing part by the heating element, and triggering a residual heat indicator to turn ON to warn a user from touching an area of the cooking field plate above the heating device.

These and further features can be gathered from the claims, description and drawings and the individual features, both singly and in the form of subcombinations, can be implemented in various embodiments of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

Exemplary embodiments are described hereinafter relative to the attached diagrammatic drawings, wherein:

FIG. 1 illustrates a view onto a heating device according to one embodiment disclosed herein,

FIG. 2 illustrates the heating device from FIG. 1 in a sectional view in a cooking field with a cooking field plate, and

FIG. 3 illustrates a diagram of the temperature on the upper surface of the cooking field plate over time.

### DETAILED DESCRIPTION

According to one embodiment, a heating device for a cooking field with a cooking field plate is designed to be arranged beneath said cooking field plate. The heating device comprises a temperature sensor and a longitudinal heating element for generating and radiating heating power in a direction to and through said cooking field plate, preferably into a saucepan placed onto said cooking field plate above the heating device. The heating power serves to keep warm the saucepan and the food contained therein for being served directly as a meal without cooking it.

The temperature sensor is provided or arranged, respectively, between said heating element and said cooking field plate. As a result, the temperature sensor is also heated by the heating element. Furthermore, the temperature sensor has a longitudinal and rod-like sensing part. Details and possible embodiments of such a temperature sensor, which may advantageously be a thermo-mechanical temperature sensor, are known in the prior art, as disclosed in, e.g., U.S. Pat. No. 4,633,238.

The heating element is arranged beneath the sensing part such that the sensing part is exposed to heating power from the heating element, advantageously only from a part or partial area of said heating element. Preferably, the sensing part is exposed to heating power from the heating element in a direct way, most preferably with short distance between the sensing part and the heating element. The heating power may range from 0.5 Watts (“W”) up to 2.5 W per centimeter (“cm”) of length of the sensing part. As a result, for example, a sensing part that is 15 cm long may be directly exposed to a heating power of 8 W up to 38 W from a part of the heating element, wherein the whole heating element may have a total power of 100 W. In comparison to the heating power of a conventional radiant heater for such cooking fields, which may have for example a heating power of 1400 W with a diameter of 16.5 cm, such values for the heating power are relatively low. However, the heating element in a conventional heater is usually not designed to heat the sensing part itself, but to heat the saucepan and, at the same time, heat the cooking field. After removing the saucepan and switching-off the heater, the temperature of the cooking field plate may be too high to be safely touched by a user, and this is the reason why a residual heat sensor in the form of a temperature sensor is employed for activating a residual heat indicator. These sensors are heated by the cooking field plate above, the cooking field plate being still hot. Typically, the residual heat indicator is activated by the heat radiated by the radiant heater only seconds after the radiant heater has been switched on. It is deactivated only after the radiant heater has been switched off and, as a consequence some time later, the temperature of the cooking field plate above has fallen under 50° C. to 90° C., so that the sensing part, which has then still been heated by the cooking field plate from above, can cool down enough to effect another switching process to switch-off the residual heat indicator.

When employing a heating element with much less power, that is not for cooking food but for the function of only keeping food warm for a long time, (i.e., with a total power of 100 W at 120 V), the heat generated by that heating element has proven insufficient to heat the temperature sensor and its sensing part enough to trigger the residual heat indicator quickly enough. In this case, the temperature of the cooking field plate can be dangerously high for a user without the temperature sensor sensing this. By directly heating the temperature sensor by exposing its sensing part to heat from the heating element or, even better, a part of it, the temperature sensor can be heated much faster and to higher temperatures than before. The switching temperature is reached faster before the temperature of the surface of the cooking field plate gets critical so that the heat indicator is activated early enough by the temperature sensor. The process of cooling down after the heating element has been switched off is the same as described before.

In one embodiment, the heating power that the sensing part is exposed to ranges from 1 W up to 2 W per cm of length of the sensing part. Surprisingly, such values for the heating power are sufficient to operate the temperature sensor with the sensing part with a correspondingly designed and adjusted sensing part.

In one embodiment, the sensing part is arranged at least partly close to a part of the heating element. This provides for a higher power input into the sensing part for generating a stronger temperature sensor reaction.

Such a heating device may have a round-circular form and a diameter of about 14 cm, with a total heating power of 100 W at 120 V. Such a total heating power may be sufficient to generate a temperature at the surface of the cooking field plate in a range of about 200° C. after about one hour, whereas it may take about nine minutes to reach 100° C. A temperature of about 200° C. on the cooking field is regarded sufficient to keep food warm in a saucepan. Of course, such a temperature should activate the residual heat indicator, because it may poses a danger to a user who may touch the cooking field. On the other hand, this temperature, which may be higher 20° C. or 30° C. on the underside of the cooking field plate, poses no threat to the mechanical stability or to the electrical properties of the cooking field plate, which may be made of glass ceramic.

In a another embodiment disclosed herein, the sensing part is arranged close to a part of the heating element, preferably with a distance of less than 2 cm, more preferably between 0.7 cm and 0.2 cm. If the sensing part is arranged substantially vertically above the heating element, then the distance can be in the range between 0.7 cm and 0.2 cm. In the case of a lateral displacement between the sensing part and the heating element, the distance may be at the lower end of this range. This may provide for a rather direct heating of the sensing part by at least this part of the heating element. Direct heating has more effect on the sensing part than only heating the air surrounding the sensing part. Furthermore, even if the heating element directly heats the sensing part, still a substantial part of this heating power also serves to heat the cooking field plate and a saucepan placed above it.

In a further embodiment disclosed herein, the sensing part is arranged close to a part of the heating element with at least 50% of its length. This serves to have a more immediate impact of the heating power to the sensing part of the temperature sensor. In an even further preferred embodiment, 70% or even 90% of the sensing part is arranged such that it is very close to a part of the heating element.

It may be advantageous to arrange the sensing part directly above at least a part, or partial area of, the heating element. Doing so not only serves to efficiently heat the sensing part with the heating element, but provides enough heating power to the sensing part to effect its switching or reaching a triggering point at a triggering temperature of the sensing part that corresponds to a temperature on the upper surface of the cooking field plate when it reaches 50° C. or approximately that value.

Furthermore, the sensing part is arranged with a substantial share of its length directly above a part of the heating element as described before. This may be 50% of its length or, in a preferred embodiment, even 75% up to 90%.

A direct heating of the sensing part with a part of the heating element allows for the use of conventional temperature sensors with a rod-like sensing part of the type known as thermo-mechanical temperature sensors, which is disclosed in U.S. Pat. No. 4,633,238. The sensing part may comprise a rod in a tube, wherein the tube is made of metal and the rod may be made of ceramic. The rod and tube have different coefficients of their thermal expansion. When exposing the sensing part to the heating power of the heating element, the increase in length of the rod and the tube are different and this length difference is used for mechanically triggering a residual heat switching device to activate the residual heat indicator. The triggering point for the residual heat switching device may be adjusted such that a temperature of the cooking field plate or its upper surface is between 50° C. and 90° C., for example between 50° C. and 60° C. This means that if such a temperature is reached at the same time the triggering point of the residual heat switching device is reached, a residual heat indicator is activated. The residual heat indicator may comprise an optical signal lamp, an audible indicator, or other type of indicators; the operation of which are well known to a person skilled in the art.

In a further embodiment disclosed herein, the heating device defines a heating area, typically being coincident with its circumference. The sensing part of the temperature sensor may at least partly span over this heating area in the manner of a chord (i.e., a line from one point on the circumference to another point on the circumference). This provides for a maximum exposure of the sensing part to the heating power from the heating element or a part thereof. If the sensing part is running over a central area of the heating area (i.e., the chord represents a diameter), it can have the greatest possible length and maximum exposure to heating power from the heating element. This results in a maximum relative movement of the rod and the tube relative to each other in the case of a thermo-mechanical temperature sensor as described before.

In another embodiment disclosed herein, the heating device is a radiant heater and the heating element is a long-stretched heating resistance, for example a heating wire with a round-cylindrical cross-section. Alternatively, it may be a wire in the form of a flat strip. The heating element may be arranged in a way to radiate radiant heating power substantially at right angle to a heating area of the heating device in a direction towards the cooking field plate and the sensing part. However, the cooking field plate and a saucepan placed upon it may be heated not only via radiant heating power through the cooking field plate, or not even mainly that way, but also or mainly by heat from the space beneath the underside of the cooking field plate. This also heats the underside of the cooking field plate for heating the saucepan placed upon the cooking field plate. This allows for lower power and lower operating temperatures of the heating element, which need not be up to 1000° C. or 1100° C. as conventional radiant heaters as described before, but can be lower than that.

Preferably, a support for the heating element forming a part of the heating device is provided with groove-like depression(s). The heating element is situated in the depression and runs along their course. The depression serves partly as a mechanical fixture for the heating element, such that it is possible to use simple staples or the like with some distance between each other to affix the heating element to the support. A support can advantageously be made of heat insulating material such as vermiculite, which has also sufficient mechanical strength to form the depressions and to hold the heating element.

In a further embodiment disclosed, the depressions have a width being only slightly above the width of the heating element, especially when this is a heating wire as described in U.S. Pat. No. 4,371,780. This may further serve as a way of fixing the heating element to the support.

In addition, a cross-section of these depressions may be such that the heating element does not extend above the depression substantially, or only up to 20% of its height. The heating element may even be situated under a surface of the support. Apart from enabling a very efficient mechanical fixing of the heating element, this serves for directing the radiant heating power rather sharply and in a focused manner to the underside of the cooking field plate. Furthermore, this allows for a selective exposure of the sensing part to radiant heating power from the heating element being placed directly underneath it.

The value of heating power, which may range from 0.5 W up to 2.5 W per cm or, in a preferred embodiment, from 1 W up to 2 W per cm, that directly heats the sensing part is defined as the momentary power. The momentary power may be upheld continuously for a long time span of at least several minutes, for example ten minutes, and up to some hours. As such, the heating element is preferably not operated in a pulsed mode or the like.

Preferably, a part of the heating element is arranged close to an outer border area of the heating device. The heating element runs along a substantial part of this outer border area. Preferably, the heating element forms the majority of a circle. The heating element can also be provided with a chord-like part, which may begin from an outer rim of the heating device and run through a central area of the heating device. In such a way, the heating element runs in a straight line corresponding to the sensing part as described above. Preferably, this is the part of the heating device that directly heats the sensing part and that defines by its power output and length together with the length of the sensing part the value of 0.5 W up to 2.5 W per cm length according to one embodiment. Whereas the sensing part may span over the whole heating device, the heating element may run beneath it for only about 75% up to 90% of the length of the sensing part.

A cooking field is provided with a cooking field plate and several heating devices arranged beneath this cooking field plate. At least one heating device, preferably exactly one heating device, is constructed in the way described above. The other heating devices may be conventional radiant heaters with a much higher power output.

The sensing part of the temperature sensor of the heating device is typically arranged close to an underside of the cooking field plate. This may be arrange in a way that in case of a temperature on the upper surface of the cooking field plate of above 50° C., the sensing part is heated with heating power of the heating device or its heating element, respectively, in a way to reach a triggering point of a residual heat switching device of this temperature sensor. This residual heat-switching device can activate the residual heat indicator, preferably an optical signaling indicator, to give a warning to a user as described before.

The method according to one embodiment provides for heating the sensing part of a temperature sensor with a heating power of 0.5 W/cm up to 2.5 W/cm of its length. This provides for triggering a residual heat display or residual heat indicator for a user. If, as has been described before, the sensing part is heated at least by a part of the heating element of a heating device directly with radiant heating power, even low total power outputs of the heating element can be sufficient to activate the sensing part of a thermo-mechanical sensor as known and used in the art. A conventional thermo-mechanical temperature sensor may be used for such a heating device to keep food warm, and at the same time to warn a user from a hot cooking field plate. Doing so may keep costs and development efforts low and allows use of reliable and proven temperature sensors.

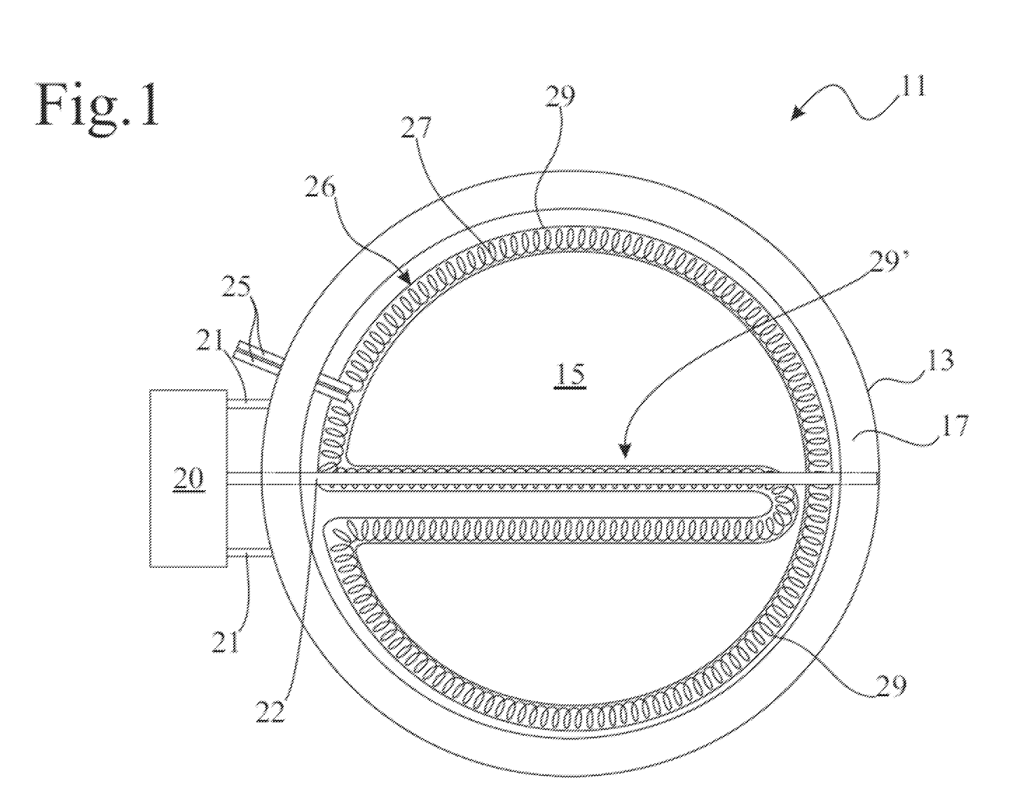

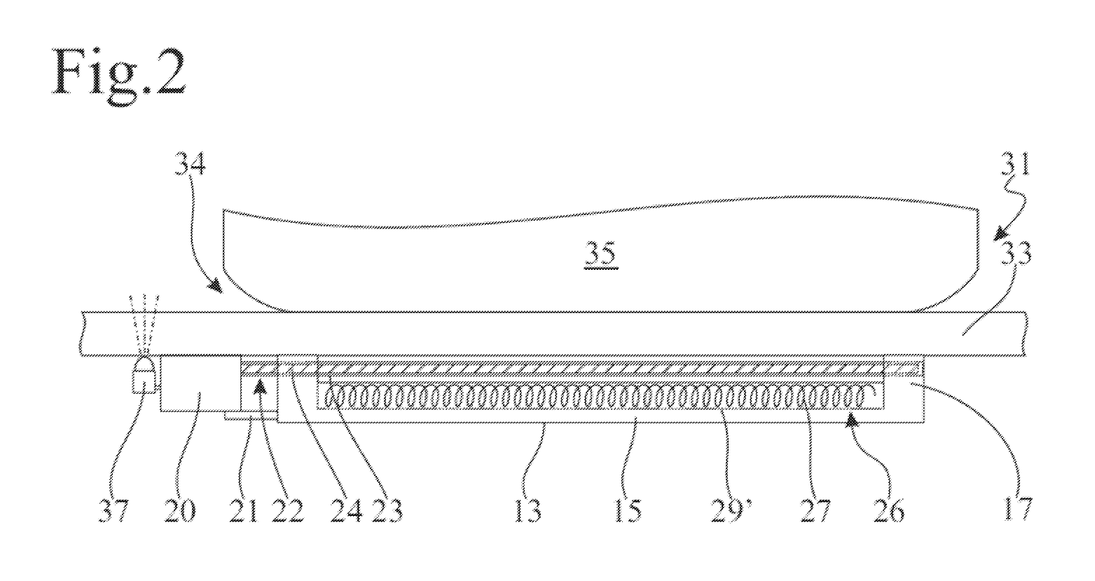

Turning now to the figures, FIG. 1 and FIG. 2 illustrate a radiant heater 11 representing a heating device as typically found in a cooktop. The radiant heater 11 may have a metal dish 13 in which is positioned a round and flat support 15, carrying in its outer area an outer ring 17. The radiant heater 17 may be pressed with this outer ring 17 against an underside of a cooking field plate 33 of a cooking field 31.

To one side of the radiant heater 11 a thermo-mechanical temperature sensor 20 may be affixed, for example by fixing brackets 21 screwed to the metal dish 13. This temperature sensor can correspond to that disclosed in U.S. Pat. No. 4,633,238, and it is provided with a long sensing part 22 comprising a metal tube 23 and a ceramic rod 24 in it. The sensing part 22 is driven through the outer ring 17 on the left side and its end is fixed in the outer ring 17 on the right side. As such, the sensing part 22 runs over the center of the radiant heater 11. The sensor part bisects the circumference and can be described as forming a chord. In the embodiment shown in FIG. 1, the chord is in the center (and thus is a diameter), but in other embodiments the chord may be positioned off-center. Other arrangements for affixing the sensing part to the out ring 17 are possible.

The radiant heater 11 may be provided with two electrical connections 25, which are connected to a heating element 26. The heating element 26 is made up of a resistance wire 27 as is known in the art, for example from U.S. Pat. No. 4,371,780, and is wound in helical form across the support 15. In one embodiment, the support is provided with a groove 29 being pressed into it or being milled out in almost a circular form with a central straight groove part 29′ through the center area. The groove can be one or more millimeters (“mm”) deep. The heating element 26 or the resistance wire 27, respectively, is located into this groove, as can be clearly seen from FIG. 2, and may be further retained mechanically in the groove by staples or the like.

It can be clearly seen that the central groove part 29′ with the resistance wire in it is directly underneath the sensing part 22 with the effect that a major part of the heating power of this portion of the heating element 26, especially the fraction of radiant heating power, goes into the sensing part 22. If the diameter of the radiant heater 11 is 16.5 cm and the diameter of the circular part of the heating element is about 13 cm, then the length of the sensing part 22 is about 14 cm and the length of the central groove part 29′ directly beneath is about 11 cm. If the total power output of the heating element 26 is 100 W, the power outputted into the sensing part 22 is about 1.3 W per cm of the length of the sensing part 22. Of course the radiant heater 11 can have a different diameter.

As can be further taken from FIG. 2, the groove 29 has a depth that a major part of the height of the heating element in helical spring form is sunk-in, for example 75% or more. This not only serves as a simple and reliable mechanical fixing, but also serves to more effectively direct a specific part of the radiant power to the sensing part 22.

The sensing part 22 may have a height of 2 to 7 mm over the heating element 26 in the central groove part 29′, and a distance of about 4 to 8 mm to the underside of the cooking field plate 33, which may be made of glass ceramic. This cooking field plate 33 is part of a cooking field 31 and defines a warming zone 34 above the radiant heater 11 for keeping food warm (“keeping warm”). A saucepan 35 is placed onto this warming zone 34.

If a user puts the saucepan onto the warming zone 34 and selects the mode of keeping it warm, the radiant heater 11 is switched on with full power, which in this embodiment, is 100 W. The radiant heater with its heating element 26 generates heat underneath the cooking field plate 33, which again makes or keeps the saucepan warm.

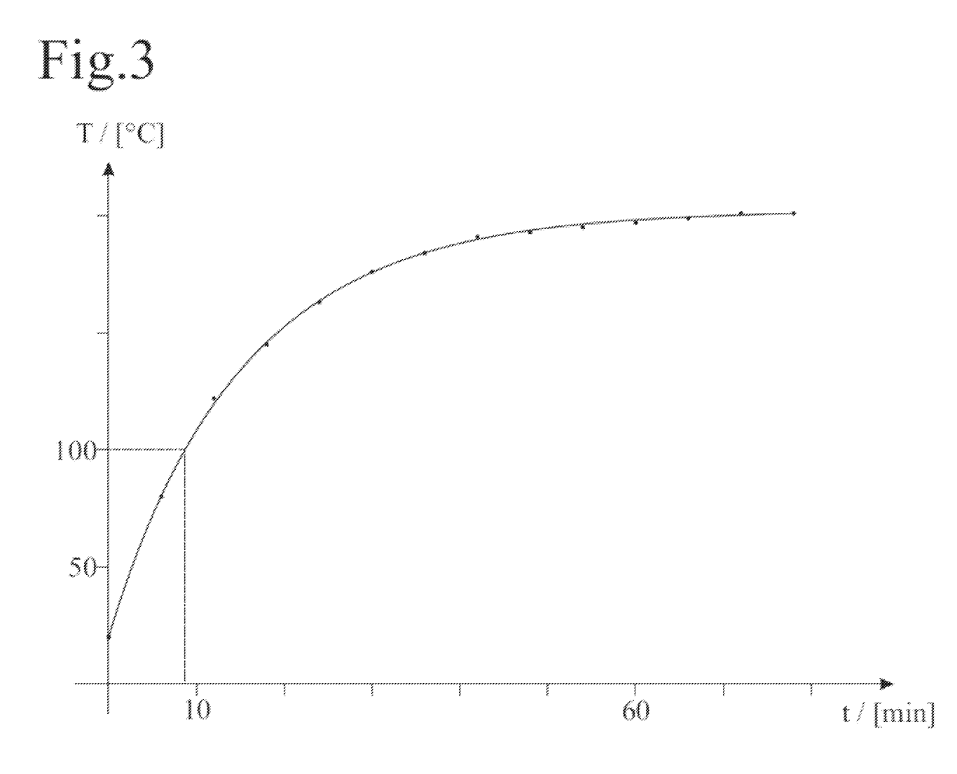

In FIG. 3, the course of the temperature on the upper surface of the cooking field plate 33 is shown, even for long durations of more than one hour. It can be taken that after 9 minutes this temperature reaches 100° C., which is definitely dangerous for a user if the saucepan is taken away.

To warn a user from touching the hot cooking field plate 33, the sensing part is directly heated by the heating element 26, or at least by a part of it, and senses a temperature corresponding to a much higher temperature than the one on the top surface of the cooking field plate 33 at this early stage of operation. This is affected by the direct heating of the sensing part 22. The temperature sensor then activates via an internal residual heat indicator, such as a “HOT” lamp 37 next to the warming zone 34. This may happen, for example, after one or two minutes of operation of the radiant heater 11, when the top surface of the cooking field plate 33 is still not too hot to touch. The HOT lamp 37 serves as a warning to a user as is known widely in the art from conventional radiant heaters.

If at any point of time a user decides to remove the saucepan and switch off the radiant heater 11, power to the heating element is cut off. After that, the sensing part 22 is exposed to the heat from the still hot cooking field plate 33 above, which begins to cool down. In a conventional way the temperature sensor 20 reaches again its triggering point for switching-off the HOT lamp 37 via the residual heat sensor when the temperature of the top surface of the cooking field plate 33 is lower than for example 50° C.

The embodiments and examples provided herein are provided by way of illustration only, and should not be construed as limiting various embodiments. Various modifications and changes may be made to the subject matter disclosed herein by one skilled in the art without departing from the true spirit and scope of the present invention, which is set forth in the following claims.

1. A heating device for a cooking appliance comprising a cooking field plate, a portion of which forms a cooking field, the heating device comprising:
a temperature sensor comprising a longitudinal and rod-like sensing part; and
a longitudinal heating element for generating and radiating heating power in a direction to and through said cooking field plate, wherein said temperature sensor is provided between said heating element and said cooking field plate, wherein said heating element is arranged under said sensing part such that said sensing part is exposed to heating power from said heating element, said heating power ranging from 0.5 W up to 2.5 W per centimeter (“cm”) of length of said sensing part.

2. The heating device according to claim 1, wherein said heating power ranges from 1 W up to 2 W per cm of length of said sensing part.

3. The heating device according to claim 1, wherein said sensing part is arranged at least partly close to a portion of said heating element.

4. The heating device according to claim 3, wherein said sensing part is arranged close to a portion of said heating element with a distance of less than 2 cm.

5. The heating device according to claim 3, wherein said sensing part is arranged with at least 50% of its length close to a portion of said heating element.

6. The heating device according to claim 1, wherein said sensing part is arranged directly above of and aligned with at least a portion of said heating element.

7. The heating device according to claim 6, wherein said sensing part is arranged with a substantial share of its length directly above said heating element.

8. The heating device according to claim 1, wherein said heating device defines a heating area within its circumference, wherein said sensing part spans over said heating area at least partly in the manner of a chord.

9. The heating device according to claim 8, wherein said sensing part runs over a center area of said heating area.

10. The heating device according to claim 1, wherein said temperature sensor is a thermo-mechanical temperature sensor, wherein said sensing part comprises a rod in a tube, and wherein said rod and said tube have different coefficients of thermal expansion.

11. The heating device according to claim 1, wherein said temperature sensor has a residual heat switching device configured to be triggered by a relative movement between said rod and said tube, said relative movement being dependent on a temperature at said sensing part.

12. The heating device according to claim 11, wherein a triggering point of said residual heat switching device is situated at a temperature at said sensing part, which corresponds to a cooking field plate temperature of between 50° C. and 90° C.

13. The heating device according to claim 1, wherein said heating device is a radiant heater and said heating element is a long-stretched heating resistance, wherein said heating element is arranged to radiate radiant heating power substantially at right angle to a heating area of said heating device in a direction towards said cooking field plate and said sensor part.

14. The heating device according to claim 13, wherein a support for said heating element is provided with a groove-like depression having a path, wherein said heating element is situated in said depression and runs along the path.

15. The heating device according to claim 14, wherein said depression has a width greater than a width of said heating element, and said depression has a depth that said only a portion of the heating element extend above the depression.

16. The heating device according to claim 1, wherein a part of said heating element is arranged close to an outer border area of said heating device, wherein said heating element runs along a substantial part of said outer border area, wherein said heating element is provided with a chord-like portion, said chord-like portion beginning from an outer rim of said heating device through a center area of said heating device and continues over the center area in a straight line.

17. A cooking appliance comprising:
a cooking field with a portion thereof forming a cooking field plate;
a heating device arranged beneath the cooking field plate, wherein the heating device comprises
a temperature sensor comprising a longitudinal and rod-like sensing part,
a longitudinal heating element for generating and radiating heating power in a direction to and through said cooking field plate, wherein said temperature sensor is provided between said heating element and said cooking field plate, wherein said heating element is arranged under said sensing part such that said sensing part is exposed to heating power from said heating element, said heating power ranging from 0.5 W up to 2.5 W per centimeter (“cm”) of length of said sensing part; and
at least one other heating device arranged beneath the cooking field plate, wherein the at least one other heating device is of different construction.

18. The cooking appliance according to claim 17, wherein said sensor part is arranged close to an underside of said cooking field plate such that in case of a temperature on an upper surface of said cooking field plate of above 50° C., said sensor part is heated with heating power of said heating device in a way to reach a triggering point of a residual heat switching device of said temperature sensor.

19. A method for operating a heating device comprising a temperature sensor comprising a longitudinal and rod-like sensing part, and a longitudinal heating element for generating and radiating heating power in a direction to and through said cooking field plate, wherein said temperature sensor is provided between said heating element and said cooking field plate, wherein said heating element is arranged under said sensing part such that said sensing part is exposed to heating power from said heating element, said heating power ranging from 0.5 W up to 2.5 W per centimeter (“cm”) of length of said sensing part,
said method comprising:
heating said heating element with a heating power of 0.5 up to 2.5 W/cm of its length;
heating said sensing part by said heating element; and
triggering a residual heat indicator to turn ON to warn a user from touching an area of said cooking field plate above the heating device.

20. The method according to claim 19, wherein said sensing part is heated at least by a part of said heating element directly with radiant heating power.
